(19) United States
(12) Patent Application Publication
(10) Pub. No.: US 2017/0257225 A1
(43) Pub. Date: Sep. 7, 2017

(54) SMART SWITCH CONTROLLING SYSTEM AND METHOD THEREOF

(71) Applicant: LUXUL TECHNOLOGY INCORPORATION, New Taipei City (TW)

(72) Inventors: CHENG-HUNG PAN, NEW TAIPEI CITY (TW); PERNG-FEI YUH, NEW TAIPEI CITY (TW); SHIUN-SHANG CHAN, NEW TAIPEI CITY (TW)

(21) Appl. No.: 15/166,677

(22) Filed: May 27, 2016

(30) Foreign Application Priority Data
Mar. 7, 2016 (TW) 105106860

(51) Int. Cl. H04L 12/28; H04W 76/02; G05B 19/042; H04L 12/24; H04L 9/06; H04W 48/16; H04L 29/12

(52) U.S. Cl. CPC H04L 12/2818; H04W 48/16; H04W 76/023; H04L 61/2015; H04L 41/0809; H04L 9/0643; G05B 19/042; H04L 61/6022; G05B 2219/2642

(57) ABSTRACT

Provided is a smart switch controlling system and a method thereof. The method includes the steps of: connecting a mobile device to a match switch; searching for a wireless base station via the match switch; connecting the match switch to the wireless base station by using the mobile device; registering the match switch at a CPnP server when the match switch and the mobile device are connected to the CPnP server; uploading registration information and a code to the CPnP server to recognize the match switch corresponding to the mobile device; when the mobile device and the match switch are connected to the CPnP server, exchanging real time information between the mobile device and the match switch via the Internet and the CPnP server.

### CROSS-REFERENCE TO RELATED APPLICATIONS

This application claims the benefit of Taiwan patent application No. 105106860, filed on Mar. 7, 2016, the disclosure of which is incorporated herein in its entirety by reference.

### BACKGROUND OF THE INVENTION

1. Field of the Invention

The present invention relates to a controlling system, and particularly to a smart switch controlling system and a method thereof.

2. Description of the Prior Arts

With rapid growth of economy, a huge number of office buildings are built. Each building has a plurality of office rooms, each room with many lamps for lighting. However, not every user is familiar with locations of switches of the lamps. Therefore, when the lamps in the room are turned off and the room is dark, the user may hardly find the switches of the lamp in darkness.

Further, brightness of each lamp may be changed by operating the switch of the lamp. The room may be lightened by natural light, but the natural light varies with time. For example, the natural light in the morning may be brighter than in the afternoon. The user has to walk to the location of the switch to change the brightness of the lamps when the natural light changes. However, going to the location of the switch to adjust the brightness of the lamps or to turn on or off the lamps is inconvenient for the user.

A conventional smart switch system may remotely turn on or off electric devices, such as lamps. Further, when the electric devices are lamps, the conventional smart switch system may remotely change brightness of the lamps. The conventional smart switch system includes a smart phone installed with a switch management application, and a user may use the smart phone to operate switches of the electric devices via Universal Plug and Play (UPnP) networking.

Electric devices mounted in a house may be connected together in a home network via the UPnP networking. When an electric device joins the home network, the joined electric device may be located by searching, and the user may use the smart phone to operate switches of the joined electric device. Namely, the user may use the smart phone to remotely control the joined electric device.

In the UPnP networking, computers may be connected, and any two devices may communicate with each other in a management of a controlling device of a local area network. The UPnP networking has six steps as follows.

Step 1. Addressing: in the UPnP networking, when a device is first connected to a network, the device may be assigned with an IP address by implementing a dynamic host configuration protocol (DHCP).

Step 2. Discovery: when the device is connected to the network and is assigned with the IP address, the device may advertise services of the device to a control device, and the device may send discoveries via a connecting port of the UPnP, such as port 1900. Further, the control device may search for devices of interest on the network, and may receive the services of the devices.

Step 3. Description: when the control device finds the device, the control device may retrieve description of the device and detailed service information from the URL provided by the device in a discovery message. The description of the device may include model name, model number, serial number, manufacturer name, or embedded services information.

Step 4. Control: when the control device has retrieved the description of the device and the detailed service information, the control device may send control messages to the device. The control messages may be expressed in eXtensible Markup Language (XML) using the Simple Object Access Protocol (SOAP). The device may send a service request of SOAP information having specific values to the control device. A processing request and a response of the control device are sent by using the SOAP.

Step 5. Event notification: state variables may be state information for keeping an UPnP device and an UPnP program. When any service is updated or the state variables are changed, messages having a new event are sent to a program or device that subscribes the event.

Step 6. Presentation: the presentation may be a human-computer interface. For example, a user may use a web browser to visit a web page of the device via a router. Then, the user may set and control the device.

As mentioned above, connecting an electronic device with a smart switch by using the UPnP networking requires complicated setting. Further, a port mapping may be implemented, but the port mapping is complex and unsafe. Therefore, the conventional smart switch system using the UPnP networking should be improved.

### SUMMARY OF THE INVENTION

To overcome the shortcomings of connecting an electronic device with a smart switch by using UPnP networking being complex and unsafe, the present invent provides a smart switch controlling system and a method thereof.

The smart switch controlling method comprises the following steps:

connecting a mobile device to at least one match switch according to a first network name of a wireless network adapter of the at least one match switch;

searching for at least one wireless base station via the at least one match switch, and sending a second network name of the at least one wireless base station to the mobile device via the at least one match switch;

connecting the at least one match switch to one of the at least one wireless base station according to the second network name by using a smart switch control interface of the mobile device; wherein the at least one wireless base station connects Internet;

connecting the at least one match switch to a commercial/consumer plug and play (CPnP) server via the at least one wireless base station and the Internet;

connecting the mobile device to the CPnP server via the Internet;

registering the at least one match switch at the CPnP server by using the mobile device;

uploading registration information of the mobile device and a code of the at least one match switch to the CPnP server; wherein the CPnP server recognizes the at least one match switch corresponding to the mobile device according to the registration information and the code;

when the mobile device and the at least one match switch are connected to the CPnP server, exchanging real time information between the mobile device and the at least one match switch via the Internet and the CPnP server.

The smart switch controlling system comprises a mobile device, a CPnP server, at least one match switch, and at least one wireless base station.

The mobile device comprises a smart switch control interface.

The CPnP server is connected to the mobile device via Internet.

Each of the at least one match switch comprises a wireless network adapter. The wireless network adapter comprises a first network name and broadcasts the first network name. The mobile device is connected to the at least one match switch according to the first network name.

Each of the at least one wireless base station comprises a second network name, broadcasts the second network name, and is connected to the Internet. The smart switch control interface of the mobile device is used to control the at least one match switch to be connected to the at least one wireless base station according to the second network name. The at least one match switch is connected to the CPnP server via the at least one wireless base station and the Internet.

When the mobile device and the at least one match switch are connected to the CPnP server, the mobile device and the at least one match switch exchange real time information via the CPnP server.

The smart switch controlling system and the method thereof eliminate the shortcomings of connecting an electronic device with a smart switch by using UPnP networking being complex and unsafe. Further, the smart switch controlling system and the method thereof transmit encrypted information to raise security of the smart switch controlling system.

### BRIEF DESCRIPTION OF THE DRAWINGS

FIG. 1 is a system diagram of a smart switch controlling system of the present invention;

FIG. 2 is a flowchart of a smart switch controlling method of the present invention; and

FIGS. 3A, 3B, and 3C are schematic views of operating procedures of a smart switch controlling method of the present invention.

### DETAILED DESCRIPTION OF THE PREFERRED EMBODIMENTS

Other objectives, advantages and novel features of the invention will become more apparent from the following detailed description when taken in conjunction with the accompanying drawings.

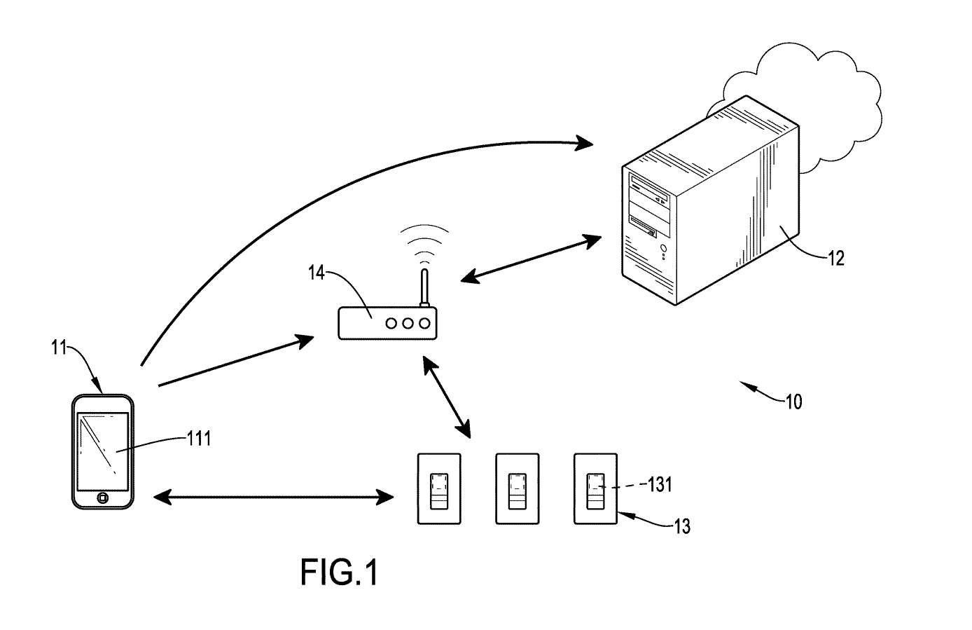

With reference to FIG. 1, the present invention is a smart switch controlling system 10 and a method thereof. The smart switch controlling system 10 comprises a mobile device 11, a Commercial/Consumer Plug and Play (CPnP) server 12, at least one match switch 13, and at least one wireless base station 14. The at least one wireless base station 14 may be connected to Internet, and stores an address of the CPnP server 12. The address of the CPnP server 12 may be an IP address or a uniform resource locator (URL) address.

In an embodiment of the present invention, the mobile device 11 may be a smart phone, a tablet, or a notebook computer. The mobile device 11 may be connected to the Internet by using the 3G or 4G technology, or via the at least one wireless base station 14, and then, the mobile device 11 may further be connected to the CPnP server 12 through the Internet. The mobile device 11 comprises a smart switch control interface 111. A user may operate the smart switch control interface 111 to register the mobile device 11 and the at least one match switch 13 at the CPnP server 12. When the user finishes registration at the CPnP server 12 and has an account of the CPnP server 12, the user may remotely control the smart switch controlling system 10. An amount of the at least one match switch 13 is corresponding to an amount of electronic device(s) controlled by the user. For example, the user may mount one match switch 13 on each electronic device. Namely, each electronic device has one match switch 13.

Each of the at least one match switch 13 comprises a wireless network adapter 131, and each wireless network adapter comprises a first network name. In the embodiment, the wireless network adapter 131 may be a WiFi adapter, and the first network name of the wireless network adapter 131 may be a Service Set Identifier (SSID). The wireless network adapter 131 of the at least one match switch 13 may broadcast the first network name. When the mobile device 11 detects the first network name broadcasted by the wireless network adapter 131, the mobile device 11 may be connected to the at least one match switch 13 via the first network name of the wireless network adapter 131.

Each one of the at least one wireless base station 14 comprises a second network name. In the embodiment, the second network name may be a Service Set Identifier (SSID). The at least one wireless base station 14 may broadcast the second network name. The at least one match switch 13 may search for the at least one wireless base station 14 by detecting the broadcasted second network name. When the at least one match switch 13 locates the at least one wireless base station 14 from searching, the user may operate the smart switch control interface 111 to connect the at least one match 13 switch to one of the searched at least one wireless base station 14 via the second network name.

The at least one match switch 13 is connected to the CPnP server 12 via the connected wireless base station 14 and the Internet. Since the at least one wireless base station 14 saves the location of the CPnP server 12, the mobile device 11 does not need to connect the at least one wireless base station 14 to the CPnP server 12.

When the at least one match switch 13 is connected to the CPnP server 12, the at least one match switch 13 is registered at the CPnP server 12 according to a code of the at least one match switch 13. The code of the at least one match switch 13 may be a Media Access Control (MAC) address. Further, when the at least one match switch 13 is connected to the at least one wireless base station 14, the first network name of the at least one match switch 13 is hidden. Therefore, a same local area network may not simultaneously have too many network names, such as the first network name and the second network name, and the second network name may be easily searched.

The at least one match switch 13 may be connected to the CPnP server 12 via the at least one wireless base station 14 and the Internet. The mobile device 11 may be connected to the Internet via the at least one wireless base station 14, or the mobile device 11 may be connected to the Internet by using the 3G or 4G technology. Then, the mobile device 11 may connect to the CPnP server 12 via the Internet. Therefore, the mobile device 11 and the at least one match switch 13 may be simultaneously connected to the CPnP server 12, and the mobile device 11 may be connected to the at least one match switch 13 via the CPnP server 12.

Further, when the CPnP server 12 transmits a control signal to the at least one match switch 13, the control signal is encrypted. For example, the control signal may be encrypted by Message-Digest Algorithm (MD5) or Advance Encryption Standard (AES) 256. Therefore, security of the smart switch controlling system 10 may be raised.

In the embodiment, the smart switch control interface 111 may be an application of the mobile device 11. When the user uses the smart switch control interface 111 of the mobile device 11, the smart switch control interface 111 may display whether the smart switch controlling system 10 is connected to the CPnP server 12, and may further display a connecting state of the at least one wireless base station 14. The smart switch control interface 111 may comprise a function of operating the at least one wireless base station 14.

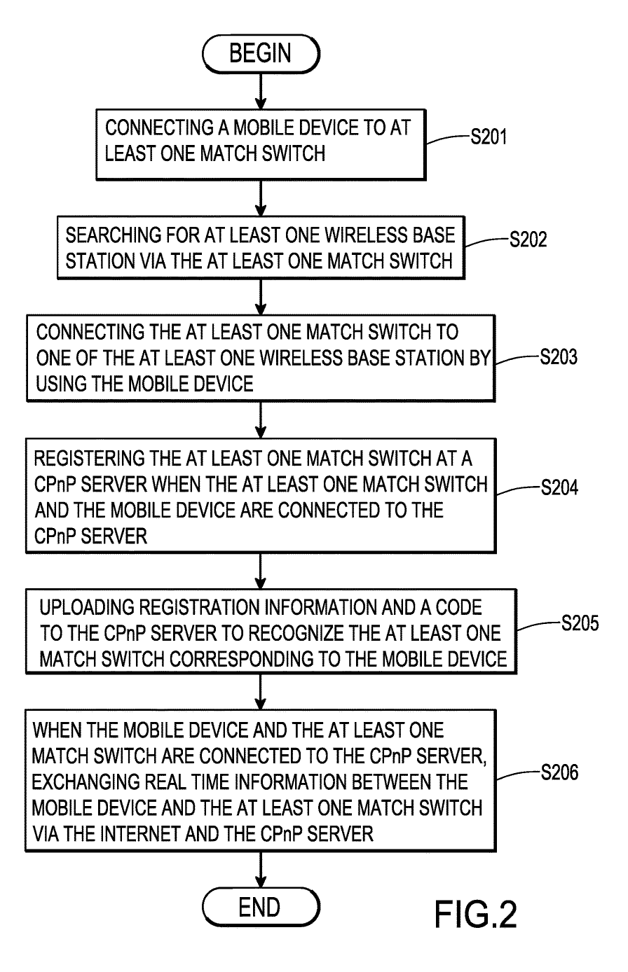

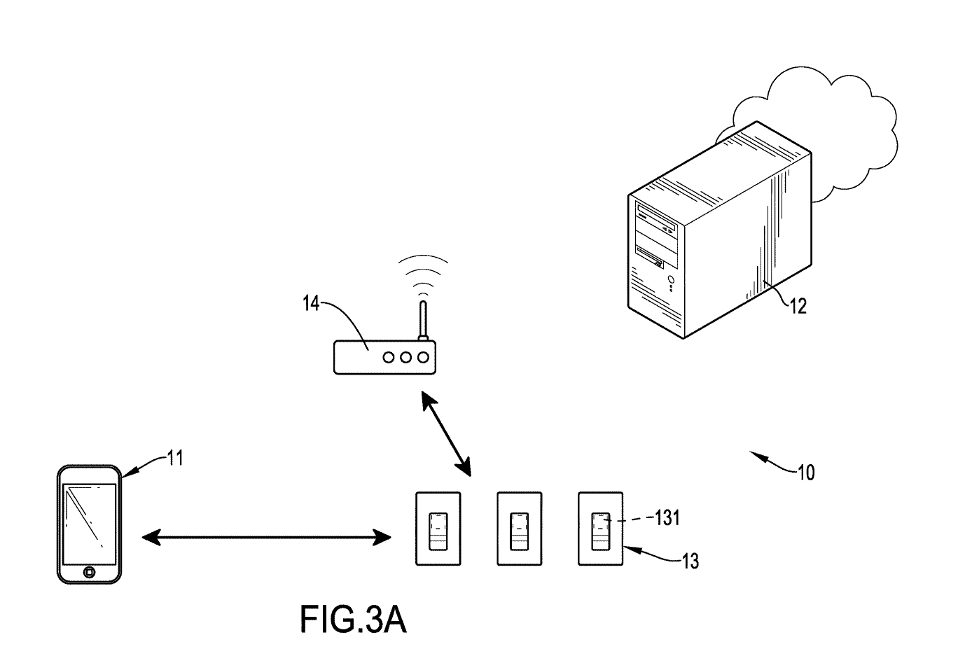

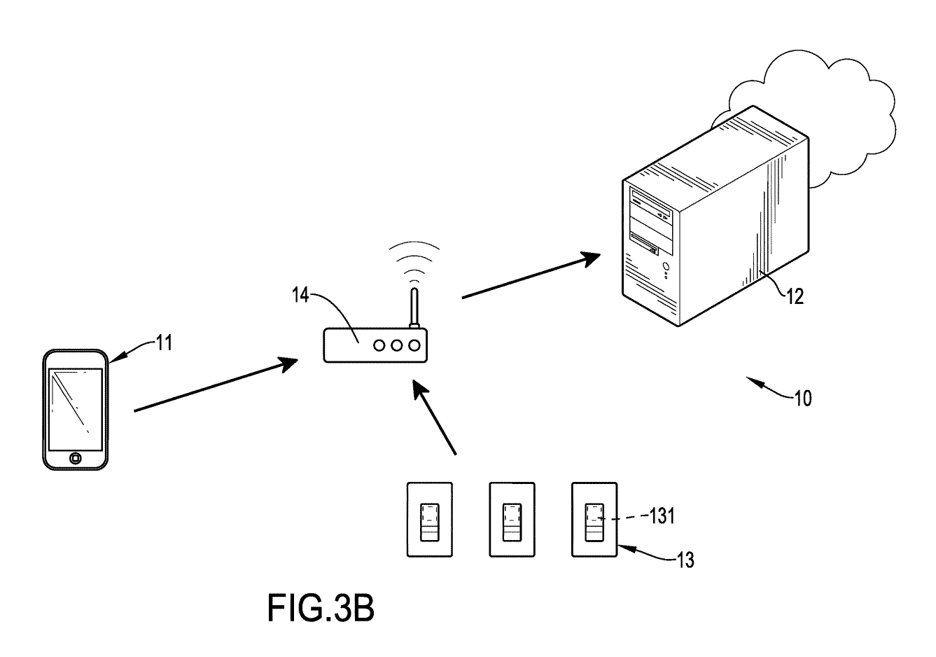

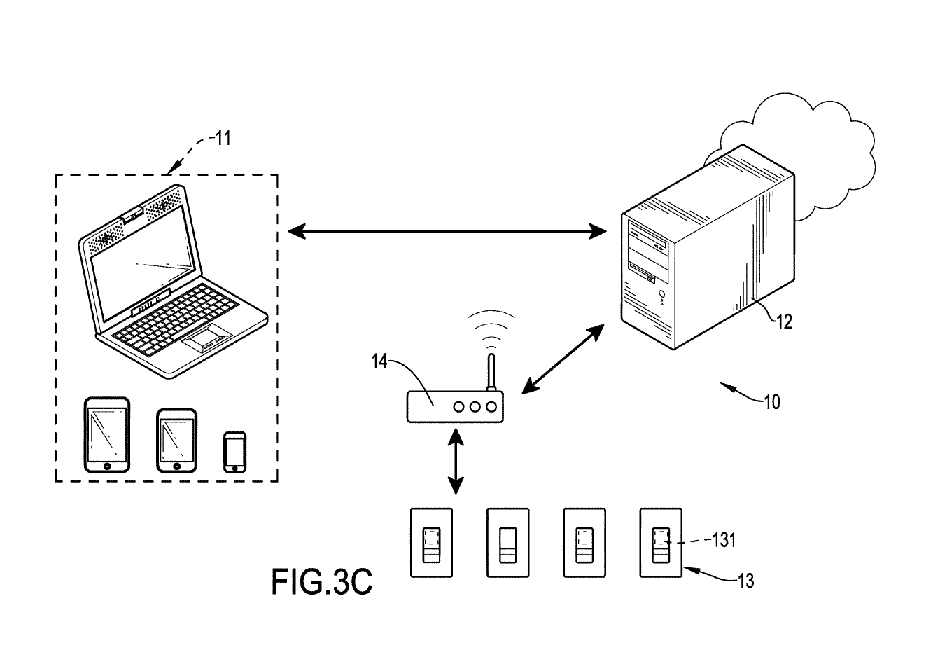

With reference to FIGS. 2, 3A-3C, the smart switch controlling method comprises the following steps.

In step S201, the mobile device 11 is connected to the at least one match switch 13 via the wireless network adapter 131 of the at least one match switch 13. The wireless network adapter 131 may broadcast the first network name, and the mobile device 11 may detect the first network name of the wireless network adapter 131 of the at least one match switch 13. Then, the mobile device 11 may be connected to the at least one match switch 13 according to the first network name.

In step S202, the at least one match switch 13 searches for the at least one wireless base station 14, and sends the second network name of the at least one wireless base station 14 to the mobile device 11. Each match switch 13 may be mounted in a respective electronic device that is controlled by the smart switch controlling system 10. As recited in FIG. 3A, since the at least one match switch 13 comprises the wireless network adapter 131, the at least one match switch 13 may search for the at least one wireless base station 14 via the wireless network adapter 131, and the at least one match switch 13 may transmit the second network name of the at least one wireless base station 14 to the mobile device 11. Therefore, the mobile device 11 may receive the second network name of the at least one wireless base station 14.

In step S203, also with reference to FIG. 3B, the user uses the smart switch control interface 111 of the mobile device 11 to connect the at least one match switch 13 with one of the at least one wireless base station 14. Since the at least one match switch 13 may not be automatically connected to the at least one wireless base station 14, the user may use the smart switch control interface 111 to control the at least one match switch 13 to be connected to one of the at least one wireless base station 14.

The user may use the mobile device 11 to connect the at least one match switch 13 with the at least one wireless base station 14. Then, the at least one match switch 13 may be connected to the Internet via the at least one wireless base station 14, and the at least one match switch 13 may be connected to the CPnP server 12 via the at least one wireless base station 14 and the Internet. Further, the mobile device 11 may be connected to the Internet via the at least one wireless base station 14, or by the 3G or 4G technology, and then, the mobile device 11 may be connected to the CPnP server 12 via the Internet.

Therefore, the mobile device 11 may be connected to the at least one match switch 13 via the CPnP server 12 to control the at least one match switch 13. The electronic device that is mounted on the at least one match switch 13 may be switched on or off by the mobile device 11, and further may be controlled to operate a function of the electronic device. For example, brightness of a lamp may be adjusted.

In step S204, when the mobile device 11 and the at least one match switch 13 are connected to the CPnP server 12, the mobile device 11 and the at least one match switch 13 may be registered at the CPnP server 12. Since the CPnP server 12 may recognize the mobile device 11 and the at least one match switch 13, the mobile device 11 and the at least one match switch 13 have to be registered at the CPnP server 12. Then, the mobile device 11 and the at least one match switch 13 may login to the CPnP server 12, and the user may use the smart switch control interface 111 of the mobile device 11 to remotely control the at least one match switch 13 via the CPnP server 12.

In step S205, when the mobile device 11 and the at least one match switch 13 are registered at the CPnP server 12, registration information of the mobile device 11 and a code of the at least one match switch 13 may be uploaded to the CPnP server 12. The registration information may be input by the user when the mobile device 11 is registered at the CPnP server 12. The code of the at least one match switch 13 may be the MAC address of the at least one match switch 13. In another embodiment, the code of the at least one match switch 13 may be any other number.

When the mobile device 11 and the at least one match switch 13 are registered at the CPnP server 12, the CPnP server 12 may recognize the mobile device 11 that is connected to the CPnP server 12 according to the registration information, and the CPnP server 12 may recognize the at least one match switch 13 that is connected to the CPnP server 12 according to the code.

In step S206, when the mobile device 11 and the at least one match switch 13 are connected to the CPnP server 12, the mobile device 11 may exchange real time information with the at least one match switch 13 via the CPnP server 12, and the mobile device 11 may monitor the at least one match switch 13. As recited in FIG. 3C, when the mobile device 11 exchanges the real time information with the at least one match switch 13 via the CPnP server 12, the real time information is encrypted by the MD5 or the AES 256. Therefore, security of the smart switch controlling method may be raised.

The smart switch controlling system 10 and the method thereof eliminates the shortcomings of connecting an electronic device with a smart switch by using UPnP networking. The security may be improved, and the port mapping may not be implemented.

Further, the mobile device 11 may control the at least one match switch 13 via the at least one wireless base station 14. When the mobile device 11 is connected to the Internet by using the 3G or 4G technology and is further connected to the CPnP server 12, the mobile device 11 may remotely control the at least one match switch 13 via the CPnP server 12.

Even though numerous characteristics and advantages of the present invention are revealed and described as above, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A smart switch controlling method, comprising steps of:
connecting a mobile device to at least one match switch according to a first network name of a wireless network adapter of the at least one match switch;
searching for at least one wireless base station via the at least one match switch, and sending a second network name of the at least one wireless base station to the mobile device via the at least one match switch;
connecting the at least one match switch to one of the at least one wireless base station according to the second network name by using a smart switch control interface of the mobile device; wherein the at least one wireless base station connects to Internet;
connecting the at least one match switch to a commercial/consumer plug and play (CPnP) server via the at least one wireless base station and the Internet;
connecting the mobile device to the CPnP server via the Internet;
registering the at least one match switch at the CPnP server by using the mobile device;
uploading registration information of the mobile device and a code of the at least one match switch to the CPnP server; wherein the CPnP server recognizes the at least one match switch corresponding to the mobile device according to the registration information and the code;
when the mobile device and the at least one match switch are connected to the CPnP server, exchanging real time information between the mobile device and the at least one match switch via the Internet and the CPnP server.

2. The smart switch controlling method as claimed in claim 1, wherein the code of the at least one match switch is a Media Access Control (MAC) address.

3. The smart switch controlling method as claimed in claim 1, wherein the real time information is encrypted by Message-Digest Algorithm (MD5) or Advance Encryption Standard (AES) 256.

4. The smart switch controlling method as claimed in claim 1, wherein the first network name of the at least one match switch and the second network name of the at least one wireless base station are Service Set Identifiers (SSID);
wherein when the at least one match switch is connected to the at least one wireless base station, the first network name of the at least one match switch is hidden.

5. A smart switch controlling system, comprising:
a mobile device, comprising a smart switch control interface;
a CPnP server, connected to the mobile device via Internet;
at least one match switch, comprising a wireless network adapter; wherein the wireless network adapter comprises a first network name and broadcasts the first network name; wherein the mobile device is connected to the at least one match switch according to the first network name; and
at least one wireless base station, comprising a second network name, broadcasting the second network name, and connected to the Internet; wherein the smart switch control interface of the mobile device is used to control the at least one match switch to be connected to the at least one wireless base station according to the second network name; wherein the at least one match switch is connected to the CPnP server via the at least one wireless base station and the Internet;
wherein when the mobile device and the at least one match switch are connected to the CPnP server, the mobile device and the at least one match switch exchange real time information via the CPnP server.

6. The method as claimed in claim 5, wherein the smart switch control interface is operated to register the mobile device and the at least one match switch at the CPnP server.

7. The method as claimed in claim 5, wherein the CPnP server encrypts the real time information by Message-Digest Algorithm (MD5) or Advance Encryption Standard (AES) 256.

8. The method as claimed in claim 5, wherein the at least one match switch is registered at the CPnP server according to a code of the at least one match switch.

9. The method as claimed in claim 6, wherein the at least one match switch is registered at the CPnP server according to a code of the at least one match switch.

10. The method as claimed in claim 8, wherein the code of the at least one match switch is a Media Access Control (MAC) address.

11. The method as claimed in claim 9, wherein the code of the at least one match switch is a Media Access Control (MAC) address.

12. The method as claimed in claim 5, wherein the mobile device uploads registration information to the CPnP server to register the mobile device at the CPnP server.

13. The method as claimed in claim 6, wherein the mobile device uploads registration information to the CPnP server to register the mobile device at the CPnP server.
